(19) United States
(12) Patent Application Publication
(10) Pub. No.: US 2008/0144562 A1
(43) Pub. Date: Jun. 19, 2008

(54) Cooperative Routing in Wireless Networks using Mutual-Information Accumulation

(76) Inventors: Stark C. Draper, Madison, WI (US); Lingjia Liu, College Station, TX (US); Andreas F. Molisch, Arlington, MA (US); Jonathan S. Yedidia, Cambridge, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 12/039,843

(22) Filed: Feb. 29, 2008

Related U.S. Application Data
(63) Continuation-in-part of application No. 11/566,846, filed on Dec. 5, 2006.
Application No. 11/566,846 is a continuation-in-part of application No. 11/377,711, filed on Mar. 16, 2006.

(51) Int. Cl. H04B 7/14; H04L 12/56

(52) U.S. Cl. 370/315; 370/400

(57) ABSTRACT

A route is selected in a wireless cooperative relay network of nodes. A decoding order is initialized. A set of resources is minimized subject to constraints. The resources are allocated to the nodes in the decoding order. The decoding order is changed iteratively to further minimize the allocated resources, until a minimum is reached. A code word is transmitted when the allocated resources are at the minimum, which can either be determined globally or locally at each node. The method can operate in a centralized or distributed manner.

### RELATED APPLICATIONS

This application is a Continuation-in-Part of U.S. patent application Ser. No. 11/566,846, “Route Selection in Cooperative Relay Networks,” filed by Molisch et al. on Dec. 5, 2007, which is a Continuation-in-Part of U.S. patent application Ser. No. 11/377,711, “Cooperative Relay Networks using Rateless Codes” filed by Molisch et al. on Mar. 16, 2006.

### FIELD OF THE INVENTION

The invention relates generally to wireless communications networks, and more particularly to routing data in cooperative relay networks.

### BACKGROUND OF THE INVENTION

In conventional relay networks, data are transmitted from a source node to a destination node via a single path with, perhaps, multiple serial hops through relay nodes.

In a cooperative relay network, wireless nodes cooperate with each other in transmitting data in parallel. By exploiting the broadcast nature of wireless channels to reach multiple relay nodes concurrently, and by enabling the relay nodes to cooperate, it is possible to reduce power consumption and/or delay in delivering data from the source to the destination. Cooperative routing can also significantly increase gains in overall throughput and energy efficiency.

Cooperative relay network are useful for low cost, low power, low complexity sensor networks. If nodes are powered by batteries, then minimizing power consumption is important. Minimizing total transmission time is one way to minimize power consumption.

Energy efficiency in cooperative relay networks is improved because the distances over which each node must transmit are often reduced significantly. Because of the increased number of transmission paths from source to destination, improved robustness to fading also results. The availability of multiple paths also results in greater network reliability to the failure of individual nodes which reduces the probability of loss of session connectivity.

The most basic form of relaying transmits data along a single route. Data are passed from one node to the next in a manner akin to a bucket brigade. This approach underlies networks according to the widely used Zigbee standard for low-rate, low-power networking. More sophisticated methods that require tighter synchronization between nodes at the physical and media access control (MAC) layer can lead to much larger performance gains.

At a high level, multihop relaying can be partitioned into two distinct problems. The first problem is the design of physical and MAC layer techniques for relaying information from one set of nodes to the next. The second problem is routing, i.e., identifying which of the available nodes should participate in the transmission and what network resources should be allocated to each. These two problems are related.

The physical layer technique strongly influences the optimum route. Most of prior art routing methods are based on physical layer techniques that either use virtual beamforming or energy accumulation. In virtual beamforming, the amplitude and phases of the signals at transmitting nodes are adjusted to interfere constructively at the receiver. Energy accumulation is performed at the receiving nodes, enabled, e.g., through space-time coding or repetition coding.

The routing protocols described in the commonly assigned parent application Ser. No. 11/377,711, “Cooperative Relay Networks using Rateless Codes” filed by Molisch et al. on Mar. 16, 2006, assume that any node that receives sufficient mutual information participates in the transmission. In a quasi-synchronous protocol, a specific scheduling scheme is assumed, and only two hops are allowed between the source and destination. A quasi-synchronous scheme makes special assumptions about the starting time of a node transmission and the duration, and allocates transmit power equally.

In the following commonly assigned application, Ser. No. 11/566,846, “Route Selection in Cooperative Relay Networks,” filed by Molisch et al. on Dec. 5, 2007, route selection is provided for networks that are unconstrained in size. That method begins with a flooding order. In a flooding order, all nodes broadcast as soon as they are able to decode the transmitted message. Then, the flooding order is optimized by dynamically adjusting routing, transmission power, scheduling, transmission time, and used codes, according to the network topology and the state of the transmission channels between the nodes. That optimization uses a brute-force numerical search of the optimal combining route, a centralized suboptimal iterative search, or a decentralized suboptimal iterative search. The specific optimizations described also include simulated annealing, which adds or subtracts one node at the time. That method is slow, has no performance guarantees, and is impractical for large networks.

It is desired to discover an optimal route for large networks in a more efficient and deterministic manner.

### SUMMARY OF THE INVENTION

Cooperation between the nodes of wireless multi-hop networks can increase communication reliability, reduce energy consumption, and decrease latency. The improvements are even greater when nodes perform mutual-information accumulation using rateless codes, such as fountain codes. Rateless codes encode data into a potentially limitless sequence of encoded symbols, such that the data can always be reliably recovered from the encoded symbols, so long as a sufficient number of encoded symbols have been received. The embodiments described herein can be used not just with rateless codes, but with any code that enables exact or approximate accumulation of mutual information.

It should be understood, that the preferred embodiments use rateless codes that achieve optimal capacity and allow information accumulation. However, non-optimal codes can also be used.

It is an objective of the invention to discover a route that optimizes resources in a cooperative wireless network using codes for mutual information accumulation. The set of resources can include delay, energy and the product of transmission time and bandwidth. A subset, i.e., one or more, of the resources in the set, is selected for optimization, and the remaining subset (one or more) of the unselected resources become constraints for the optimization.

The embodiments provide methods for determining a route in a cooperative wireless network of nodes that include a source node, multiple relay nodes, and a destination node. The route specifies the nodes that participate in transmitting a data message from the source node to the destination node using rateless codes and information accumulation.

The method for discovering routes includes both centralized and distributed embodiments.

One embodiment uses linear programming (LP) to determine a decoding order, and allocate resources to select an optimal route. The decoding order can be improved systematically by changing the order of nodes based on the solution of the LP. The changing can include exchanging nodes in the decoding order, adding nodes to the decoding order, or removing nodes from the decoding order. Solving a sequence of LPs leads to an optimal solution in an efficient manner.

It should be noted that the decoding order of the nodes is not necessarily the same as the ordering of the nodes in the route because a node that decodes may not retransmit the data message, and therefore does not participate in the route.

The embodiments of the invention solve for locally optimal routes assuming that the calculation of the route can be done at a central node that has access to full channel state information (CSI) for the entire network. These assumptions can be relaxed so that only local channel state information is used. A distributed method finds routes that are only about two to five percent less efficient than the centralized method.

On the average, the cooperative transmission with mutual information accumulation according to the invention decreases delay and energy usage by about 70% when compared with conventional non-cooperative shortest path multihop routing.

### BRIEF DESCRIPTION OF THE DRAWINGS

FIGS. 1 and 2 are diagrams of cooperative relay networks according embodiments of the invention;

FIG. 3 is a block diagram of a communication protocol according to an embodiment of the invention; and

FIG. 4 is a flow diagram of a method for routing according to an embodiment of the invention.

### DETAILED DESCRIPTION OF THE PREFERRED EMBODIMENTS

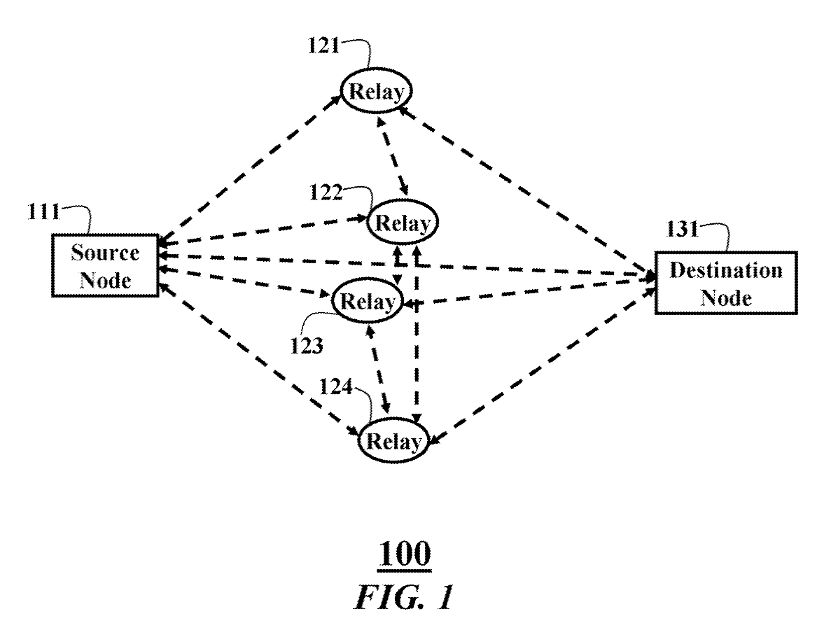

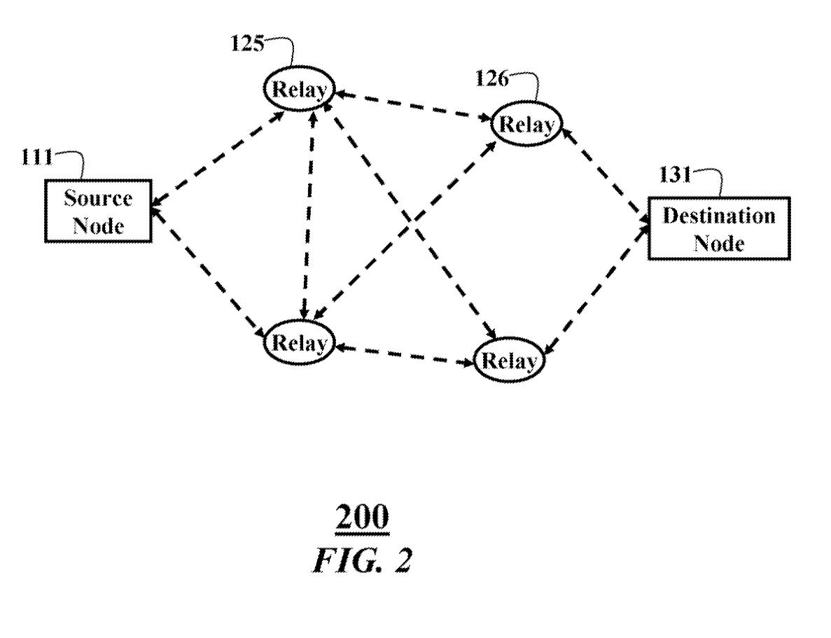

FIGS. 1 and 2 show cooperative relay networks 100 and 200 according to embodiments of our invention. The cooperative relay network 100 includes a source node 111, a set of N relay nodes 121-124, and a destination node 131, i.e., source, relays, and destination, respectively.

It should also be understood, that the embodiments of the invention can also by used with multiple relay ‘hops’ as shown in FIG. 2. In this case, relay 125 also acts as a ‘source’ for an ‘intermediate’ relay 126. This scheme can be extended to additional hops. It should be understood, that a practical network, such as a network of sensors in a large manufacturing plant, refinery or office building can include tens or perhaps hundreds of nodes, which makes the optimal route determination non-trivial. Particularly, brute force numerical approaches or iterative searches, as known in the art, become impractical.

It is desired to optimize resources, e.g., delay, energy or the product of time and bandwidth. A subset of one or more of the resources is selected for optimization, while a subset of unselected resources becomes constraints for the optimization.

The source node transmits a data message to the destination node via a set of N relay nodes. The data message can be, for example, a file or packet of data bytes. The relay nodes can use, for example, decode-and-forward techniques. Some of the relays nodes can operate in parallel. The data message contains B bits.

The source, as well as the relays, uses rateless codes for encoding the data message. The decoding nodes use information accumulation. All nodes operate in half-duplex mode, i.e., a node either transmits or receives, but not both simultaneously.

In the following, we allow transmission with a direct-sequence spectrum spreading technique. Such an approach is useful for relay networks, as it allows different data streams to be transmitted in parallel and in a flexible way, such that the data streams can be distinguished at the receiver.

The transmit power of all nodes is P_{T}. The propagation channels between the nodes are modeled as frequency-flat, block fading channels. The channel gains are independent and exponentially-distributed, corresponding to Rayleigh fading of the amplitudes. It is assume that channel state information (CSI) can be acquired centrally, or in a local distributed manner at each node.

These assumptions are made only to provide an example; different multiple access schemes, as well as different transmit powers for the different nodes, possibly varying with the remaining battery lifetime, different models for channel gains, the average or instantaneous CSI, can be used in conjunction with the embodiments of our invention.

Our receivers are mutual information accumulating receivers. These receivers can distinguish the various data streams transmitted by different relays that might arrive at the receiver concurrently. For example, the receivers can use multi-user detection to distinguish the different rateless codes.

The receivers include rateless code decoders, so that data streams from different relay nodes can be distinguished, and the mutual information of signals transmitted by relay nodes can be accumulated. In one embodiment of the invention for a CDMA network, the different nodes use different spreading codes in order for the destination node to separate the different data streams and to accumulate the information contained in the data streams. Techniques, such as successive cancellation wherein data streams are sequentially decoded and subtracted from the measured observation to cancel out interference, can also be applied.

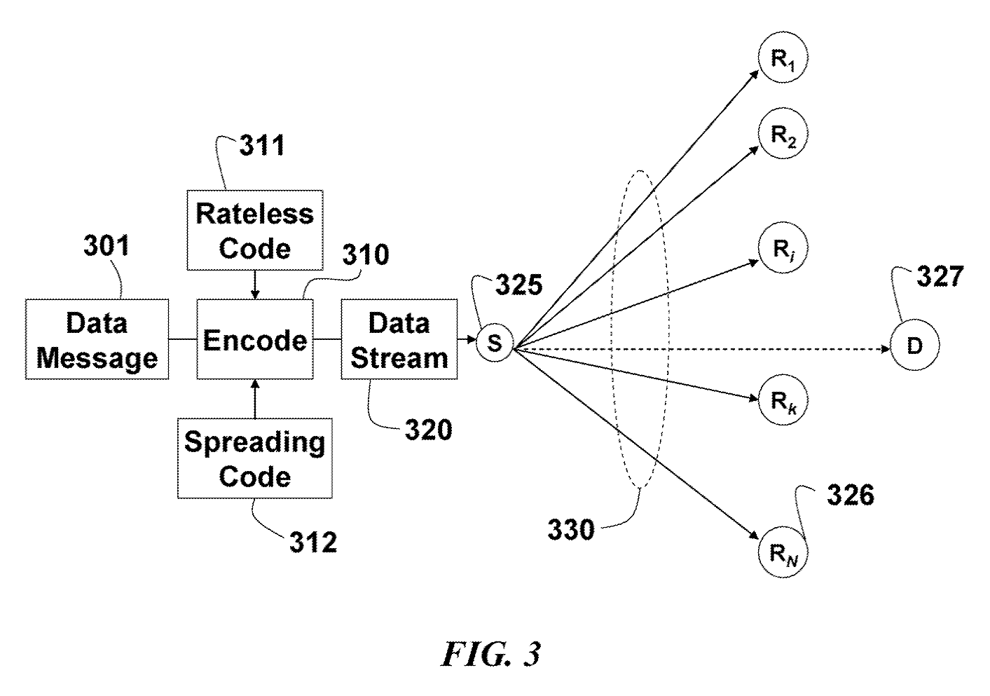

As shown in FIG. 3, a codeword 301 is encoded 310 using a rateless code 311 and, optionally, a spreading code 312 to produce a data stream 320. The data message 301 can be any arbitrary accumulation collection of bits or ‘information,’ for example, a packet. A source node (S) 325 broadcasts 330 the data stream to be eventually received by the destination (D) 327, perhaps via a set of relay nodes (R) 326. The broadcast of the data can be in the form of packets. Hereinafter, the term data stream and packets refer to the encoded data message or symbols being transmitted.

It is an object of the invention to determine which nodes along a route participate in forwarding the data message. Only participating nodes re-encode and retransmit the data message. Thus, resources consumed can be minimized, in contrast with the flooding technique of the prior art.

Network Model

For simplicity of this description we first describe a uni-cast network of N+1 nodes, where only L+1 nodes participate in the information transmission. The intermediary nodes (non-source, non-destination) are the relays. Multiple data streams can be transmitted in parallel over quasi-orthogonal channels.

It is one objective of the invention to transmit a data message composed of B bits from the source to the destination with minimum delay under energy and bandwidth constraints. Alternatively, we can minimize energy, while constraining the delay and bandwidth to fixed values, or minimize the time-bandwidth product used, while fixing the delay and energy.

Relays take an active role in the transmission, or may possibly remain silent for the duration of communication. To simplify our analysis, we assume that a node's only significant energy expenditure lies in transmission, and that reception, decoding, and re-encoding entail no significant energy overhead when compared with transmission. We note that these assumptions can be relaxed within the framework described herein.

All node-to-node transmissions are assumed to use rateless codes. Rateless codes encode information bits into a potentially infinite-length codestream. Symbols are continually sent by the transmitter until the receiver is able to decode. We assume that the rateless codes are ideal in the sense that they can perform at the Shannon limit, at any data rate.

We also assume that the receiver can accumulate information received from two or more different transmitters. Each transmitter uses an independently generated rateless code. This design aspect is important for mutual information accumulation. If the same rateless code were used by each transmitter, the receiver would obtain multiple versions of each symbol of the data message. This is “energy-accumulation.” By receiving different codes generated from the same information bits the receiver accumulates mutual information rather than accumulated energy, as is typically done in the prior art.

Intuitively, the difference between energy accumulation and mutual information accumulation can be understood from the following simple example. Consider binary signaling using two transmitters, each with an erasure channel to a receiver with an erasure probability pₑ. If the two relays use repetition coding, corresponding to energy accumulation, then each bit is erased with probability pₑ², so 1−pₑ² bits are received on average per transmission of the two transmitters.

In contrast, if the two transmitters use different rateless codes, the transmissions are independent and on average 2(1−pₑ) bits per transmission of the two transmitters is received, which exceeds 1−pₑ² bits.

Any node in our network can accumulate information from transmitting nodes to recover the data message. The only requirement for decoding is that the total received mutual information, summed over all transmitting nodes, exceeds B bits. We account for the non-ideal nature of rateless codes by incorporating into our formulae an overhead factor of (1+ε), where (1+ε)B bits is the number of bits that are sent before decoding is successful.

We assume that the i^{th} node operates at a fixed transmit power spectral density (PSD) Pᵢ (joules/sec/Hz), uniformly across its transmission bandwidth. The propagation channel, between each pair of nodes, is modeled as frequency-flat and block fading.

The channel power gain between the i^{th} and the j^{th} nodes is h_{i,j}. Under these assumptions, the spectral efficiency, in terms of bits per second per Hertz, of data transmission from node i to node j, following Shannon's formula, is

$${C}_{i , j} = {log}_{2} [ 1 + \frac{{h}_{i , j} {P}_{i} {W}_{i}}{{N}_{0} {W}_{i}} ] = {log}_{2} [ 1 + \frac{{h}_{i , j} {P}_{i}}{{N}_{0}} ] bits \text{/} s \text{/} Hz . \qquad ( 1 )$$

where N₀ denotes the PSD of a white noise process, and Wᵢ denotes the transmission bandwidth of node i.

Due to the block-fading nature of the channel, our routing method can be performed for arbitrary channel coefficients. If the channels are time-varying (fading), the routing can be done for each channel realization separately.

The network can also operate under energy and bandwidth constraints. We describe the case where these resources are constrained on a per node basis and also the case where the constraints are imposed on the total for all nodes.

Centralized Routing

To find the network parameters, i.e., route and resources, which yield the minimum end-to-end delay under total energy and total bandwidth constraints, we decompose the problem into two sub-problems.

The first sub-problem is the determination of the subset of nodes that can participate in relaying the data message and the order in which the nodes decode. Because a node cannot start to transmit until it has decoded the data message, the decoding order is equivalent to the order in which nodes are able transmit.

The second sub-problem is the determination of the optimal transmission parameters for a given decoding order. These include the timing of the transmissions of each node and the bandwidth allocations.

For a given decoding order, we may find that some of the nodes that decode do not retransmit. We distinguish the decoding order and the routing order, because some of the nodes that decode may not participate in the final route. Therefore, the final route only includes nodes that both decode and transmit.

As described below, the problem of finding the optimal transmission parameters can be posed as a linear program (LP). The LP optimizes a linear objective function, subject to linear equality and inequality constraints. Put very informally, LP tries to get the best outcome, e.g., minimum delay, energy or bandwidth, given some set of constraints.

In one embodiment, the solution of our LP generates the transmission parameters that yield the minimal delay routing for the current decoding order. This solution can then be used to refine the decoding order, resulting in a new decoding order whose minimal delay route is at least a good as that of the current order. Our method for determining the final route and resource allocation iterates between (a) finding a new decoding order with a lower delay or fewer transmitting nodes based on the LP solution of the previous decoding order, and (b) performing a linear program to find the optimal resource allocations for the current decoding order. This iterative procedure finds a very good locally optimal route, and often a globally optimal route.

Optimizing Resource Allocation for Fixed Decoding Order

Of the N+1 nodes in the network, we consider a subset of L+1 nodes that form a particular decoding order. Without loss of generality, the nodes are labeled according to their current decoding order: 0, 1, 2, . . . , L where node 0 is the source and node L is the destination. We describe how to solve for the optimum resource allocation that achieves the minimum duration transmission of the data message of B bits under various resource constraints.

We use units such that the time T₀ when the source (node 0) transmits is zero. The time at which node i decodes the data message is denoted Tᵢ. The total source-to-destination transmission time is T_{L}. However, instead of working with the time Tᵢ, it turns out to be more useful to work with the inter-node delays Δᵢ, where Δᵢ=Tᵢ−Tᵢ₋₁ for 1≦i≦L.

The data transmission can be thought of as having L phases. The i^{th} phase has a delay Δᵢ, and is characterized by the fact that at the end of the phase the first i nodes have all decoded the data.

We refer to each phase as a “time-slot.” The time-slots are not of pre-set or equal lengths, rather their lengths are solved for as part of the optimization problem.

For one embodiment, in which the source-to-destination delay is minimized, we now state the objective function of the routing problem for a given decoding order as a linear function of the delays Δᵢ. Our objective is to minimize the total delay

$${T}_{L} = {\sum }_{i = 1}^{L} {Δ}_{i} , \qquad ( 2 )$$

where Δᵢ≧0 for all i, subject to the following constraints:
node i must decode by time

$${T}_{i} = {\sum }_{l = 1}^{i} {Δ}_{l} , \qquad$$

the energy constraints, and
the bandwidth constraints.

We describe the constraints in turn. First, we consider the decoding constraints. We express each of the L such constraints as

$${\sum }_{i = 0}^{k - 1} {\sum }_{i = i + 1}^{k} {A}_{i , j} {C}_{i , k} \geq B \\ for all k ∈ \{ 1 , 2 , … , L \} , \qquad ( 3 )$$

where A_{i,j} are the time-bandwidth resources, in terms of seconds times Hz used by the i^{th} node in the j^{th} time slot. C_{i,k}, is the spectral efficiency of the channel connecting the i^{th} transmitter to the k^{th} receiver. The spectral efficiency is expressed in terms of bits per second per Hz; see Equation (1). The k^{th} node is required to decode by the end of the k^{th} transmission phase. Therefore, the total mutual information flow to the k^{th} node exceeds B bits by the end of the k^{th} time slot. Only the first k−1 nodes can contribute to this total. The remaining nodes have not yet decoded, so they cannot yet transmit.

Not all N+1 nodes in the network need be included in the decoding order, only a subset of cardinality L+1. If one node, neither source nor destination, is far from the rest, or masked by a building, then including it in the set will increase the total delay T_{L}. For this reason we do not force all nodes to be included in the decoding order.

We provide a “change order” procedure that improves the decoding order. The change-order procedure sometimes drops nodes from the decoding order. Such nodes are then no longer treated as part of the network, and L is decreased by one in the next LP. Conversely, nodes can be added back into the order as well. For example, we can check if for the current LP solution any nodes that had previously been dropped from the order are now able to decode before the destination. If this is the case, reintroducing such nodes into the order as the last nodes in the order before the destination would not obviate the feasibility of the current solution. Other node reintroduction protocols can also be combined with the approach now being described.

We limit the energy and the time-bandwidth allocations to the resources available. We differentiate between two possible types of constraints: total constraints that apply to the total allocation across all nodes and per node constraints applied to each node individually.

Overall, we consider four cases, with total or per node energy constraints, and total or per node bandwidth constraints. In the following, we describe the specifics of each case.

Total Energy Constraint

First, we consider a total energy constraint, which has the form

$${\sum }_{i = 0}^{L - 1} {\sum }_{i = 1}^{L} {A}_{i , j} {P}_{i} = {\sum }_{i = 0}^{L - 1} {\sum }_{i = i + 1}^{L} {A}_{i , j} {P}_{i} \leq {E}_{T} , \qquad ( 4 )$$

where the equality holds because A_{i,j}=0 for j≦i. This is true because node i has not decoded until the end of time slot i, and therefore can only transmit (and therefore would only be allocated positive time-bandwidth product) in slots i+1, . . . , L.

Per Node Energy Constraint

Instead of a total energy constraint, we may use per-node energy constraints. We replace Equation (4) in our constraint set with

$${\sum }_{j = i + 1}^{L} {A}_{i , j} {P}_{i} \leq {E}_{i} \\ for all i ∈ \{ 1 , 2 , … , L \} . \qquad ( 5 )$$

As another alternative, the energy used per node can be scaled by a function that is inversely proportional to its remaining battery power in order to maximize a lifetime of the network, i.e., the time when the first node runs out of battery power.

Total Bandwidth Constraint

One possible resource constraint limits the total allocation of the time-bandwidth product in each time slot summed over all nodes. The time-bandwidth product allocated to node i in slot j is A_{i,j}. The total allocation made in time-slot j is constrained such that

$${\sum }_{i = 0}^{j - 1} {A}_{i , j} \leq {Δ}_{j} {W}_{T} \\ for all j ∈ \{ 1 , 2 , … , L \} . \qquad ( 6 )$$

A couple of aspects of this constraint are worth noting. First, the specific bandwidth allocation to each node within each transmission phase is not specified. This is because we model the fading as block-fading and frequency-flat. Because the time-bandwidth product is treated flexibly, the optimal solution under total bandwidth constraints can always be implemented by scheduling just one node to transmit at any given instant. Thus, in time slot j, we can allocate the entire bandwidth to node i for a duration A_{i,j}/W_{T}. The ordering of transmissions within a time slot is immaterial because only at the end of the time slot do we require the next node in the decoding order to be able to decode.

This strategy is quite different from non-cooperative multi-hop networks due to the mutual information accumulation at each node, which requires information accumulation. Because of the broadcast nature of the wireless medium, each node is accumulating useful information from all previous transmissions until it decodes. The decoding process thus has a very long memory. The memory makes it impossible to solve for the best route efficiently through dynamic programming. The computational load of a brute force search is too high for large networks consisting of tens of nodes. In contrast, in non-cooperative multi-hop routing, each node accumulates information only from its immediate predecessor. The end result is that the route ultimately generated by our method is quite different from that of conventional multi-hop networks.

Per Node Bandwidth Constraint

An alternate constraint on bandwidth involves dividing the spectrum into parallel equal-bandwidth channels of bandwidth W_{node}, where each node is allocated at most a single channel in each time slot. Instead of the L constraints in Equation (6), this model results in L² constraints, one per node per time slot:

$${A}_{i , j} \leq {Δ}_{j} {W}_{node} \\ for all \begin{matrix}i ∈ \{ 0 , 1 , … , L - 1 \} \\ j ∈ \{ 1 , 2 , … , L \}\end{matrix} . \qquad ( 7 )$$

Alternate Objective Functions

Our method accommodates a number of other objectives. For example, instead of the objective being delay-minimization as in Equation (2) we can minimize the total energy expenditure

$${\sum }_{i = 0}^{L - 1} {\sum }_{j = i + 1}^{L} {A}_{i , j} {P}_{i} ,$$

subject to the end-to-end delay constraints

Σᵢ₌₁^{L}Δᵢ≦τₜₒₜ

as well as bandwidth constraints.

Alternately, we can minimize the time-bandwidth product. This would allow for parallel transmissions between different source-destination pairs within the network under consideration, or could be used to minimize inter-network interference when multiple networks are operating in the same area. In this case the objective function is

$${\sum }_{i = 0}^{L - 1} {\sum }_{j = 1}^{L} {A}_{i , j}$$

subject to the delay and energy constraints.

In place of the unicast setting, a multicasting problem can also be addressed in the current framework by appropriately adjusting the objective function and constraints. Multicasting is described further below.

Optimizing Decoding Order

Our LP formulation above solves for the optimum resource allocations for a given decoding order. We now address the question of how to determine the best decoding order.

In a network of N+1 nodes there are

$${\sum }_{i = 0}^{N} \frac{( N - 1 ) !}{( N - 1 - i ) !}$$

distinct orderings. Exhaustive search of all possible orderings is impractical. Therefore, we provide a procedure that iteratively improves the decoding order by exploiting the characteristics of the LP solution.

The procedure progressively reduces the delay by reordering the nodes in the decoding order until a route with locally optimal delay is obtained.

Because our procedure is computationally efficient, we can try a number of different initializations to avoid particularly bad local minima.

An arbitrary decoding order is selected to initialize the procedure. Without loss of generality, we label the nodes in the initial decoding order as [0, 1, . . . , L]. We define

x*=[Δ₁*, . . . , Δ_{L}*,A_{0,1}*,A_{0,2}, . . .A_{0,L}*A_{1,2}* . . . A_{L-1,L}*],

to be the optimum solution obtained by the linear program for the initial decoding order. We denote the optimum decoding delay as

T_{L}*=Σᵢ₌₁^{L}Δᵢ*

The following theorem holds when subject to either total bandwidth or per node bandwidth constraints, and either total energy or per node energy constraints.

Theorem: If Δᵢ*=0, use T_{L}** to denote the optimum decoding delay under the same energy and bandwidth constraints of the “changed” decoding order:

$$[ 0 , … , i - 2 , i , i - 1 + 1 , … , L ] if i \leq L - 1 \\ [ 0 , … , L - 2 , L ] if i = L \\ Then {T}_{L}^{**} \leq {T}_{L}^{*} . \qquad ( 8 )$$

If i=L, the changed decoding order consists of only L nodes, because node L−1 has been removed from the decoding order.

Method for Route and Resource Allocation

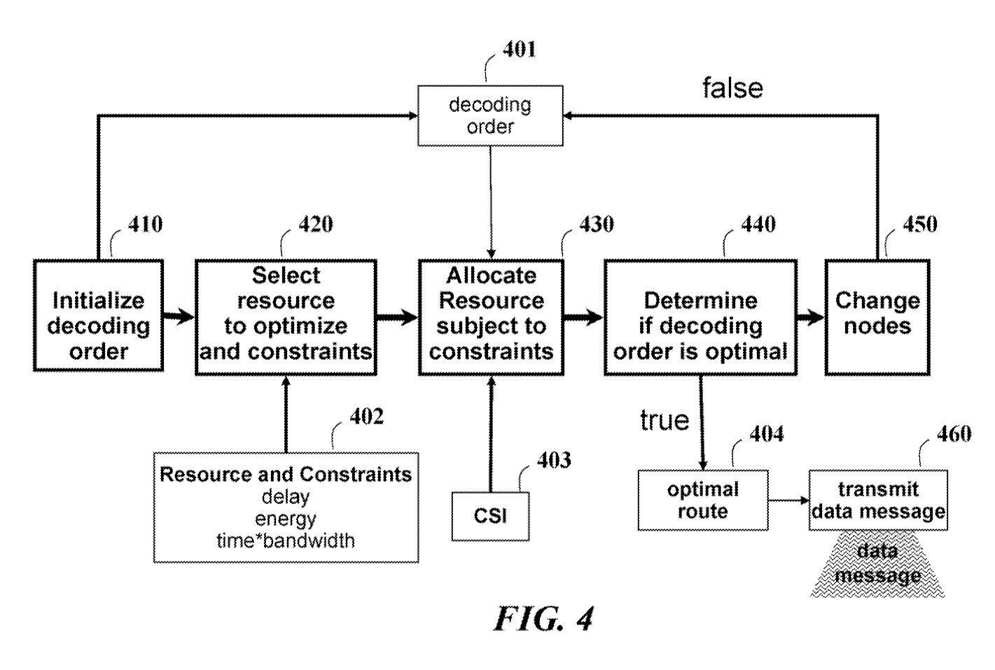

FIG. 4 shows a method for determining a route in a cooperative wireless networks according to an embodiment of the invention.

A decoding order 401 is initialized 410. The initial order can be the flooding order, a random order, an order obtained from a distributed method, or some other arbitrary order.

A set of resources 402 is defined. For example, the set of resources include delay, energy and transmission time-bandwidth product. A subset (one or more) of resources is selected 420 for optimization, the unselected subset (one or more) of the set are used to constrain the optimization.

We allocate 430 the resource, subject to the constraints, to nodes in the current decoding order, using linear programs. The allocation can be based on the total for the resource for all nodes for a global optimization, or on a per node basis for a locally optimal solution. The optimization can also use channel state information (CSI) 403. The optimization can be performed in a centralized manner at one of the nodes, or in a distributed manner, as described below.

Then, we determine 440 if the decoding order is optimal. If false, we change 450 nodes in the decoding order 401 and repeat. Otherwise, if true, we have our optimal route 404. For example, if the resource to be optimized is delay, then the delay is upper bounded by the delay of the previous solution, and we change 450 the decoding order according to the following rules:

### If Δᵢ=Δⱼ=0 for i<j−1, then we exchange both nodes i and i−1 and j and j−1. If Δᵢ=Δᵢ₊₁=0, then we exchange only nodes i and i−1.

If the node L−1 is exchanged with node L, then remove the former node L−1 from the order entirely. Now, the resulting decoding order constrains only L−1 nodes.

### If all nodes have a delay Δᵢ>0, then the decoding order is locally optimal and no more changes are made, and the data message can be transmitted 460.

Because the number of constraints in the linear program is linear with respect to a size of the network size, our routing method can be applied to relatively large networks.

Depending on whether the resource constraints are per-node or total allocation, the method can be combined with an additional optimization. We describe the differences between the per-node bandwidth and total bandwidth cases, assuming a total energy constraint.

Per-Node Bandwidth Constraint

In this case, there is tradeoff between energy and delay. If we initialize the method at the target total energy constraint and an arbitrary decoding order, then we typically find that Δ*ᵢ=0 for multiple i. This is a problem because it is not clear how to change the ordering. Therefore, we provide the following approach.

We initialize the method with the decoding order that corresponds to “flooding” the network. This solution fully relaxes the energy constraints, allowing nodes unlimited energy consumption in order to achieve the minimum delay transmission. This starting point is found as is now described. The source node starts transmitting. Other nodes join in and begin transmitting as soon as they decode. All nodes continue to transmit until the destination decodes. The order in which nodes transmit is the flooding order.

Initializing the basic routine with the flooding order, we tighten the energy constraints slightly. We re-optimize the decoding order under the new energy constraint. If the energy constraint now equals the target energy, then terminate the method. Otherwise, we use the new decoding order, and repeat.

We can solve a sequence of optimizations using this method under tighter and tighter energy constraints until the target energy is met. The optimized route found under one energy constraint is used to initialize the method under the next, slightly tighter, energy constraint. As with most nonlinear iterative optimization routines, the choice of step size is important.

The step size can correspond to the increment by which the energy constraints are tightened. Ideally, the energy constraints are tightened only enough that a single Δ*ᵢ=0. This can typically be accomplished by making the increment small or dynamically selecting the increment. Thus, if the energy constraint is tightened too much, then we reduce the increment and re-optimize.

Total Bandwidth Constraint

It is possible to prove that under the total bandwidth constraint for the special case Pᵢ=P the minimum energy and minimum delay transmission schemes are the same. In this situation the energy backoff is not needed because there is no energy-delay tradeoff. Thus, only the basic method is required to generate routes in this case.

Characteristics of Final Route

The changing of nodes out of the decoding order can keep our method from necessarily reaching the global optimum. The achieved optimum might be either a local or global optimum, depending on the initial decoding order.

When the L−1^{th} node is exchanged with node L (the destination), it no longer enters the LP formulation. This makes the decoding constraint of Equation (3) easier to meet. The intuition is that some nodes are quite a bit further from the source than the destination and enforcing their ability to decode via Equation (3) increases the objective, e.g., the end-to-end transmission delay, significantly.

It is possible to achieve a local optimum that is not a global optimum if the final decoding order includes nodes that should not be in the decoding order.

Multicasting

In the basic multicasting scenario, we have one or more source nodes, and all nodes decode. The only needed change in the various versions of the LP stated in Equations (3)-(6) is that L becomes N. For multicasting, we need to reach all N other nodes. In contrast to the unicasting case, multicasting nodes are never dropped from the decoding order. Therefore, the main cause for local optimality described above is obviated. Therefore, we should nearly always achieve the global optimum using our approach. The one caveat is step-size. It is important to reduce the energy constraint between LP iterations in small enough increments that only one Δᵢ goes to zero per iteration.

There is also a multicasting problem between unicasting and basic multicasting, where we require some subset of the N+1 to decode. This scenario is also easy to incorporate into our framework. One simply never drops any of these multiple “destination nodes” from the decoding order. In term of the LP, node L is the index of the last of these destinations to decode.

Distributed Routing

It is often not desirable or even possible to centralize the routing method by centralized routing methods like the ones described above. In centralized routing, all channel state information (CSI) must be aggregated at a central location. The central location can be any designated node in the network. The resulting routing information is then dispersed from the central location throughout the network.

Limitations on centralized routing are particularly constraining in the following circumstances. In large networks, the number of possible channels, and thus the CSI that has to be dispersed, increases as (L+1)!, where L is the number of nodes in the network. Therefore, aggregating the CSI of all possible channels at the central location can incur an unacceptable overhead if the number of nodes, L, is large.

Even in small, temporally varying networks, the CSI can be outdated by the time it arrives at the central location. To address these issues, we describe two distributed routing methods.

First Distributed Routing Method

Our first distributed routing method commences with a direct transmission from the source node to the destination node. In an iterative manner, intermediate relay nodes are added to the route.

Specifically, the source node broadcasts a first sounding signal. Based on this sounding signal relay nodes estimate the channel state information (CSI) of the channel from the source to them. The destination node then broadcasts a second sounding signal. The second sounding signal can be the same as, or different from the first. Each relay node then estimates the CSI of the channel between them and the destination based on the second sounding signal. Given the CSI, each relay node determines an energy reduction if the node were to participate in the route. The energy reduction is

$$\frac{B}{{W}_{T}} \frac{( {C}_{i , L} - {C}_{0 , L} ) ( {C}_{0 , i} - {C}_{0 , L} )}{{C}_{0 , i} {C}_{0 , L} {C}_{i , L}} ,$$

where B is the number of bits in the data message, W_{T} is the total system bandwidth constraint, C is the spectral efficiency of the channel between two nodes as subscripted, and L is the number of nodes, as before. Each node broadcasts the energy reduction using any of the many possible contention multiple access schemes.

The source node transmits the data message with mutual information accumulation, and the node with the highest energy saving is selected to participate in the route and to retransmit the data message. At this time the source node can terminate transmission.

In the next step, the CSI from the selected node to all other nodes in the network is determined by having the relay broadcast a relay sounding signal. Again, all nodes determine whether they can reduce energy by joining the route. The process is repeats until no further energy reductions are possible.

Because both the source the destination and the selected nodes broadcast a sounding signal, the routing inherently gets the data message signal to the destination node. In other words, a route leading away from the destination node would not lead to energy savings, and thus would not be considered.

Second Distributed Routing Method

A somewhat simpler distributed routing method can be implemented as follows. The destination node broadcasts a sounding signal and the relay nodes estimate their CSI to the destination node from the sounding signal. Each relay nodes broadcast its CSI information to all other nodes in the network. Then, the source node transmits the data message. Of the nodes that can decode the data message, the first node that has a better channel connecting it to the destination node (better than the direct source-to-destination channel) then “replaces” the source node and retransmits the data message. At this time, the source node stops transmitting and the first relay starts transmitting. The processing continues, with new relay nodes continue to replace previous nodes, in the same manner, until the data message reaches the destination node.

### EFFECT OF THE INVENTION

The invention provides a method for routing in cooperative relay networks that use mutual-information accumulation. Our model assumes the use of ideal rateless codes. We split the problem into one of finding a best decoding order and one of finding the best resource allocation for the decoding order. As our solution is based on solving a sequence of linear programs, it is simple and numerically efficient, even for large networks.

We also show that under equal per-node PSDs and total bandwidth constraints, the minimum-delay solution also minimizes energy consumption. Further, this solution yields a transmission schedule that calls for only a single node to be actively transmitting at any specific time. All the same, our routing is markedly different from conventional shortest-path routing, with the delay and energy usage of our method being about 70% less in typical examples.

We also provide a distributed method that retains most of the performance gains without requiring centralized knowledge of channel state information. The invention can be used to implement practical cooperative communications in large networks.

Although the invention has been described with reference to certain preferred embodiments, it is to be understood that various other adaptations and modifications can be made within the spirit and scope of the invention. Therefore, it is the object of the append claims to cover all such variations and modifications as come within the true spirit and scope of the invention.

We claim:

1. A method for selecting a route in a wireless cooperative relay network of nodes, the nodes including a source node, a set of relay nodes, and a destination node, comprising the steps of:
initializing a decoding order for the set of relay nodes and the destination node;
selecting, from a set of resources, a subset of resources to minimize subject to a subset of unselected resources in the set of resource to constrain the minimization;
allocating the subset of selected resources to the nodes in the decoding order subject to the constraint of the subset of unselected resources;
determining whether the allocated subset of resources is minimized with respect to the decoding order;
changing, if false, the decoding order and repeating the allocating and determining steps; otherwise, if true
selecting the nodes in the decoding order as an optimal route; and
transmitting and decoding a data message from the source node to the destination node via the optimal route using mutual information accumulation.

2. The method of claim 1, in which the set of resources includes delay, energy and a product of a time and a bandwidth used to transmit the data message.

3. The method of claim 1, further comprising:
encoding the data message as a data stream using a code that enables the mutual information accumulation; and
decoding the data stream using the mutual information accumulation.

4. The method of claim 1, in which the determining step further comprises:
minimizing the subset of selected resources locally per node.

5. The method of claim 1, in which the determining further comprises:
minimizing the subset of selected resources globally for the network.

6. The method of claim 1, in which the allocating depends on instantaneous channel state information of channels between the nodes.

7. The method of claim 6, further comprising:
approximating a spectral efficiency of the transmitting, in terms of bits per second per Hertz, between two nodes as
$${C}_{i , j} = {log}_{2} [ 1 + \frac{{h}_{i , j} {P}_{i} {W}_{i}}{{N}_{0} {W}_{i}} ] = {log}_{2} [ 1 + \frac{{h}_{i , j} {P}_{i}}{{N}_{0}} ] bits \text{/} s \text{/} Hz ,$$
where a power gain of the channel between node i and a node j nodes is h_{i,j}, N₀ denotes a power spectra density of a white noise process, and Wᵢ is the transmission bandwidth of node i.

8. The method of claim 6, in which the channels are time-varying.

9. The method of claim 1, in which the changing comprises exchanging nodes in the decoding order, adding nodes to the decoding order, or removing nodes from the decoding order.

10. The method of claim 1, in which the allocating uses linear programming and an objective function minimizes a total delay.

11. The method of claim 1, in which the allocating uses linear programming and an objective function minimizes a total energy consumed in the network.

12. The method of claim 2, in which the allocating uses linear programming and an objective function minimizes a maximum of the energy consumed per node in the network.

13. The method of claim 12, in which the energy consumed per node is scaled by a function that is inversely proportional to a remaining battery power of the node in order to maximize a lifetime of the network.

14. The method of claim 2, in which the allocating uses linear programming and an objective function minimizes a sum of the products of the times and bandwidths for all nodes.

15. The method of claim 1, in which the initial decoding order is a flooding, random, obtained from a distributed routing method, or arbitrary.

16. A method for selecting a route in a wireless cooperative relay network of nodes, the nodes including a source node, a set of relay nodes, and a destination node, comprising the steps of:
broadcasting, by the source node, a first sounding signal;
estimating, by the relay nodes, channel state information (CSI) to the source node from the first sounding signal;
broadcasting, by the destination node, a second sounding signal;
estimating, by each relay node, the CSI to the destination node from the second sounding signal;
determining, by each relay node and based on the CSI at the relay node, an energy reduction if the relay node were to participate in the route;
broadcasting, by each relay node, the energy reduction;
selecting the relay node with a highest energy reduction to participate in the route;
repeating, the steps of:
broadcasting from the most recently selected relay node, a relay sounding signal;
estimating, by all relay nodes not yet selected for participation in the route, the CSI to the selected relay node based on the relay sounding signal;
determining, by each relay node not yet selected for participation in the route and based on the CSI at the relay node, the energy reduction if the relay node were to participate in the route;
broadcasting, by each relay node not yet selected for participation in the route, the energy reduction; and
selecting a next relay node with the highest energy reduction to participate in the route until no further energy reduction is possible, and then
transmitting and decoding a data message, using mutual information accumulation, from the source node to the destination node via the selected relay nodes in an order that the relay nodes were selected when no further energy reduction is possible and the route is established.

17. The method of claim 16, in which the source node terminates the broadcasting after the selecting.

18. The method of claim 16, in which the energy reduction is
$$\frac{B}{{W}_{T}} \frac{( {C}_{i , L} - {C}_{0 , L} ) ( {C}_{0 , i} - {C}_{0 , L} )}{{C}_{0 , i} {C}_{0 , L} {C}_{i , L}} ,$$
where B is a number of bits in the data message, W_{T} is a total system bandwidth constraint, C is a spectral efficiency of the channel between two nodes as subscripted, and L is a number of nodes.

19. A method for selecting a route in a wireless cooperative relay network of nodes, the nodes including a source node, a set of relay nodes, and a destination node, comprising the steps of:
broadcasting, by the source node, a sounding signal;
estimating, by the relay nodes channel state information (CSI) based on the sounding signal;
broadcasting, by each relay node, the CSI;
broadcasting, by the source node, a data message using mutual information accumulation; and
selecting iteratively the relay node that decodes the data message using the mutual information accumulation and has a best CSI to rebroadcast the data message unit the data message is decoded by the destination node.

20. A wireless cooperative relay network of nodes, comprising:
a source node;
a set of relay nodes;
a destination node;
means for initializing a decoding order for the set of relay nodes and the destination node;
means for selecting, from a set of resources, a subset of resources to minimize subject to a subset of unselected resources in the set of resource to constrain the minimization;
means for allocating the subset of selected resources to the nodes in the decoding order subject to the constraint of the subset of unselected resources;
means for determining whether the allocated subset of resources is minimized with respect to the decoding order, and means for changing the decoding order and repeating the allocating and determining if false; otherwise if true
means for selecting the nodes in the decoding order as an optimal route; and
means for transmitting a data message from the source node to the destination node via the optimal route using mutual information accumulation.
